(19) United States
(12) Patent Application Publication
(10) Pub. No.: US 2026/0097879 A1
(43) Pub. Date: Apr. 9, 2026

(54) FOOD ROTATION AND LABELING SYSTEM

(71) Applicant: INNOVATIVE TECHNOLOGIES BY DESIGN, INC., MELBOURNE, FL (US)

(72) Inventor: JASON BRETT MOBLEY, MELBOURNE, FL (US)

(21) Appl. No.: 19/350,670

(22) Filed: Oct. 6, 2025

Related U.S. Application Data
(60) Provisional application No. 63/703,522, filed on Oct. 4, 2024.

(51) Int. Cl. B65C 11/02; B65C 9/40

(52) U.S. Cl. CPC B65C 11/0205; B65C 9/40; B65C 2009/408

(57) ABSTRACT

A food rotation and labeling system includes an alert station operatively coupled to a label maker. The label maker prints labels each having a unique identifier linked to a digital database maintained by the alert station having a processor, a memory, and a display screen. The processor is configured to store the unique identifier and associated food data including at least a preparation date and an expiration date in the memory. The processor is also configured to generate a graphical user interface (GUI) displayed on the display screen and configured to present the food data and status of each food container. In addition, the processor is configured to display an alert on the display screen and transmit the alert to a mobile device when a food container is approaching expiration or has expired.

### RELATED APPLICATIONS

This application claims the benefit of U.S. Provisional Application Ser. No. 63/703,522 filed Oct. 4, 2024, which is hereby incorporated herein in its entirety by reference.

### FIELD

The present invention relates to the field of commercial food inventory management systems, and, more particularly, to a food rotation and labeling system.

### BACKGROUND

Food rotation in restaurant food preparation is a systematic approach used to manage and use food inventory efficiently, ensuring that ingredients are used in the order they are received and before they spoil. This practice minimizes food waste, maintains food safety, and ensures the freshness of the dishes served to customers. The process typically follows the First In, First Out (FIFO) method, where the oldest stock is used first. FIFO rotation is not limited to restaurants, but is also critical in cafeterias, grocery stores, institutional kitchens, hospitals, and other environments where large volumes of food are stored and served.

FIFO ensures that older inventory is used before newer items. When receiving new stock, it is placed behind or below existing stock so that older items are used first. This method helps prevent food spoilage and waste, ensuring that ingredients stay fresh. In practice, FIFO requires continuous monitoring of storage areas, accurate recordkeeping, and consistent staff discipline to place and retrieve food items in the proper order.

In existing systems, food rotation is commonly enforced by manually labeling food containers with dates of receipt or preparation. These labels may be handwritten, stamped, or printed using stand-alone label makers. Staff are then responsible for visually checking labels, recording expiration dates in logbooks, and discarding expired food items. Regular checks of food inventory and storage areas are conducted to ensure that the rotation system is being followed correctly and that no expired or spoiled items are present. By following proper food rotation practices, restaurants and other food service organizations can maintain high standards of food safety and quality while minimizing waste and reducing costs.

However, the effectiveness of this process is highly dependent on the accuracy and consistency of staff. Handwritten labels may be illegible, damaged by condensation or handling, or fall off entirely. Staff may miscalculate expiration dates, neglect to rotate stock properly, or fail to conduct regular inspections. Even when printed labels are used, existing label printers typically function as stand-alone devices with no connection to a centralized database. Once a label is printed and applied, there is no automated tracking of the food item, and staff must still rely on manual monitoring.

These shortcomings result in wasted food, increased costs, and potential health risks if expired items are accidentally served. In regulated environments such as hospitals or institutional kitchens, failure to properly track and rotate food can result in noncompliance with health and safety standards, exposing organizations to fines, liability, or reputational damage. Existing inventory management software systems are often too complex, expensive, or poorly adapted for fast-paced kitchen environments, leaving many operations without an effective solution.

Proper training is essential for restaurant staff to understand food safety procedures. However, the lack of proper training, high staff turnover, and time pressure in commercial kitchens often result in lapses in following proper procedures. Consequently, food may not be rotated correctly, expired items may remain in storage, and regulatory requirements may not be consistently met.

Accordingly, there is a need for a system that can more efficiently and easily maintain food safety standards, minimize the risk of foodborne illness, ensure compliance with regulatory requirements, and reduce waste. Such a system should combine automated labeling with unique identifiers, digital recordkeeping, real-time alerts, and remote monitoring to eliminate reliance on manual processes and reduce human error.

### SUMMARY

In view of the foregoing background, it is therefore an object of the present invention to improve food inventory management and compliance through automated tracking and real-time alerts. The system includes an alert station operatively coupled to a label maker. The label maker is configured to print labels having unique identifiers, which are affixed to respective food containers. Each unique identifier corresponds to a digital record stored in a database maintained by the alert station. The digital record includes food data such as a preparation date, expiration date, storage location, and current status.

A graphical user interface (GUI) of the alert station provides centralized access to the stored data, allowing users to view, filter, and update records associated with each food container. The system is further configured to generate alerts when a food item is approaching expiration or has expired. These alerts are displayed on the alert station and transmitted to mobile devices to ensure timely action.

In certain embodiments, the system can generate printed lists of label identifiers for physical inspections, provide escalation of alerts to supervisory users, and integrate with external systems such as point-of-sale or enterprise resource planning platforms. Optional features include machine-readable indicia on labels, environmental sensors for dynamic expiration adjustment, and cloud synchronization for multi-location monitoring.

In another aspect, a method of managing food inventory using a food rotation and labeling system is disclosed. The method includes generating, by an alert station, a label having a unique identifier and printing the label using a label maker. The label is affixed to a food container, and the unique identifier along with associated food data such as a preparation date and expiration date are stored in a database of the alert station. The method further includes monitoring the stored food data, automatically updating a status of the food container, and generating an alert when the food container is approaching expiration or has expired. The alert is displayed on the alert station and transmitted to a mobile device. The method may additionally include scanning labels to update status information, generating printed inspection lists, recording a history of user actions, and escalating unacknowledged alerts to supervisory personnel.

In another aspect, a labeled food container is disclosed. The container includes a body configured to store food and a label affixed to the body. The label includes a unique identifier corresponding to a record stored in a database of an alert station. The record includes food data such as a preparation date and an expiration date. In certain embodiments, the label further includes machine-readable indicia such as a barcode or QR code encoding the unique identifier. The label may be formed from water-resistant, freezer-safe, or dissolvable materials, and may include color-coded indicators corresponding to freshness status. By linking each container to a digital record, the labeled container enables item-level traceability and monitoring not achievable with traditional handwritten or static labels.

### BRIEF DESCRIPTION OF THE DRAWINGS

The aspects and the attendant advantages of the embodiments described herein will become more readily apparent by reference to the following detailed description when taken in conjunction with the accompanying drawings wherein:

FIG. 1 is a block diagram of a food rotation and labeling system in which various aspects of the disclosure may be implemented;

FIG. 2 is a perspective view of the food rotation and labeling system including an alert station coupled to a label maker, in accordance with the present disclosure;

FIG. 3 is a schematic of food containers with labels affixed to a front surface, illustrating unique identification and tracking of individual containers;

FIG. 4 is an example of a label generated by the alert station of FIG. 2, the label including a unique identifier and machine-readable indicia;

FIG. 5 is a graphical user interface (GUI) displayed by the alert station of FIG. 2, providing a list of tracked food items and associated status data;

FIG. 6 is a detailed view of the GUI of FIG. 5, illustrating alert icons that indicate items expiring soon or expired;

FIG. 7 is an alert displayed on the alert station of FIG. 2 and a schematic of the alert being transmitted to a mobile device;

FIG. 8 is a GUI of the alert station of FIG. 2 showing detailed data related to a Label ID and associated food item record; and

FIG. 9 is a schematic of a printed list generated by the alert station of FIG. 2, showing Label IDs and food data for physical inspection.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

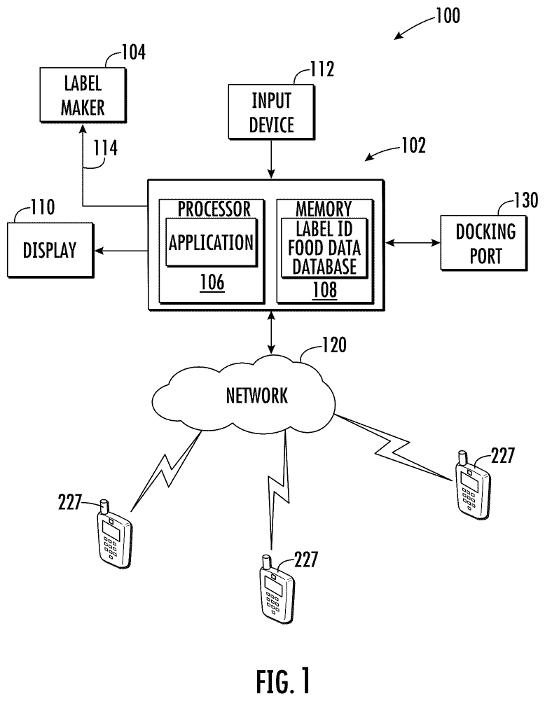

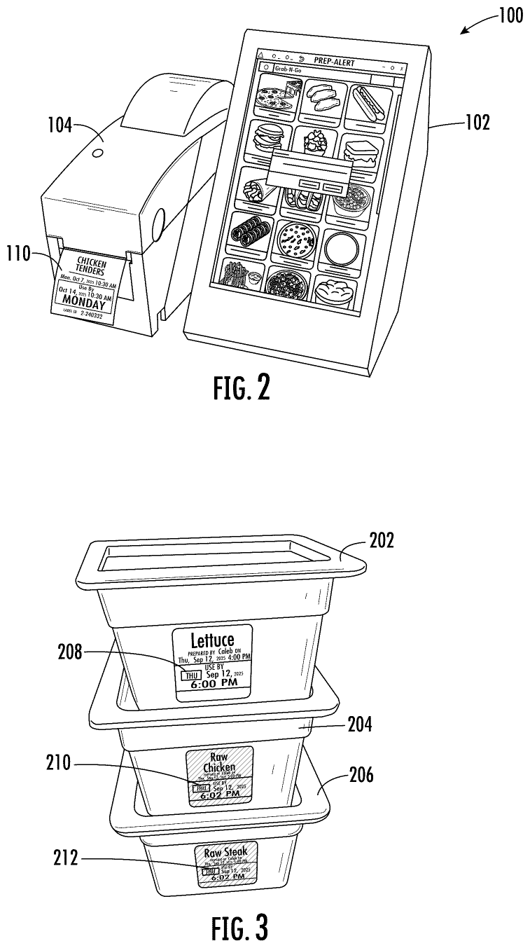

Referring now to FIGS. 1 and 2, a food rotation and labeling system 100 is shown and generally designated 100. The system 100 includes an alert station 102 that is operatively coupled to a label maker 104. The alert station 102 may be implemented as a stand-alone electronic device with an integrated housing, or as a software-controlled module operating on a general-purpose computing platform such as a tablet, personal computer, or dedicated kiosk. In certain embodiments, the alert station 102 comprises a processor 106, a memory 108, a display screen 110, and an input device 112, all housed within a compact enclosure suitable for placement on a countertop or wall mount in a food preparation environment.

The processor 106 may include a microcontroller, microprocessor, or system-on-chip configured to execute instructions stored in the memory 108. The processor 106 is configured to store the unique identifier and associated food data including at least a preparation date and an expiration date in the memory. The processor 106 is also configured to generate a graphical user interface (GUI) displayed on the display screen 110 and configured to present the food data and status of each food container. In addition, the processor 106 configured to display an alert on the display screen 110 and transmit the alert to a mobile device 227 when a food container is approaching expiration or has expired.

The memory 108 stores program instructions, databases of Label IDs, expiration rules, and user accounts. The display screen 110 is configured to present the graphical user interfaces (GUIs). The input device 112 may comprise a touchscreen integrated with the display, physical buttons, a keyboard, or a barcode/QR code scanner. In some embodiments, a voice recognition module may be provided for hands-free operation, particularly beneficial in food service environments where operators frequently wear gloves.

The label maker 104 is coupled to the alert station 102 through a communication interface 114. The communication interface 114 may be a wired connection, such as USB, or a wireless connection, such as Wi-Fi or Bluetooth. The label maker 104 is configured to print adhesive labels that include human-readable text (e.g., food type, preparation date, expiration date) as well as machine-readable codes (e.g., barcode 246 or QR code 248). In one embodiment, the label maker 104 is physically integrated with the alert station 102 in a single housing, while in another embodiment it is a peripheral device located remotely but wirelessly paired to the alert station 102.

The alert station 102 also includes a network communication module 120. This network communications module 120 provides connectivity to external networks, including local area networks and cloud-based servers. Through the network communication module 120, the alert station 102 can synchronize label data with a cloud database, transmit alerts to mobile devices 227, and allow administrators to remotely manage multiple alert stations across different facilities.

The housing of the alert station 102 may be manufactured from materials suitable for food service environments, such as stainless steel, coated aluminum, or impact-resistant polymer. In some embodiments, the housing is rated for splash resistance (e.g., IP54 or higher) to withstand spills or cleaning operations common in kitchens.

In use, the alert station 102 coordinates the entire food rotation and labeling process. When a user places a new food container into storage, the user interacts with the GUI on display screen 110 to input the category of food, preparation date, or other relevant data. The processor 106 then assigns a unique Label ID, stores the information in memory 108, and instructs the label maker 104 to print the label. The label is affixed to the food container, and the corresponding Label ID is stored in the database.

The alert station 102 may include a docking port 130 for attaching peripheral devices such as a tablet computer, smart phone, or external display. When docked, the peripheral device may serve as the primary GUI while the alert station 102 handles processing and label printing. This modularity allows the system to scale from small household use (tablet-based) to large institutional use (dedicated kiosk with network integration).

The improvements of the present system 100 over prior systems are substantial. Existing labeling stations generally function as stand-alone printers without integrated monitoring or modular expansion options. They may generate a simple printed label but do not retain a digital record, cannot synchronize with mobile devices, and lack flexibility for deployment in different environments. By contrast, the alert station 102 of the present disclosure integrates hardware, software, and modular expansion capabilities into a unified system. This integrated and expandable approach reduces reliance on manual oversight, minimizes food waste, ensures regulatory compliance, and enables managers to remotely monitor operations in real time across multiple facilities.

Referring now to FIG. 3, a plurality of food containers 202, 204, and 206 are illustrated, each bearing a respective label 208, 210, and 212. The containers may be rigid, semi-rigid, or flexible, and may be formed from a variety of materials such as plastic, stainless steel, glass, or coated paperboard. In commercial kitchens, containers 202, 204, and 206 may be standard gastronorm pans, deli containers, or storage bins.

Each of the labels 208, 210, and 212 is affixed to an exterior surface of the respective food container, preferably the front-facing surface that remains visible when the container is placed in a refrigerator or storage shelf. The placement of labels on the front surface allows staff to quickly scan or visually confirm the information without having to lift or open the containers, which reduces handling and improves sanitary practices.

The labels 208, 210, and 212 may be adhesive-backed paper labels, thermal-printed labels, or polymer labels designed to withstand cold, moisture, and repeated handling. In one embodiment, the labels are printed using water-resistant, food-safe adhesives that remain affixed during refrigeration or freezing. In another embodiment, the labels may be peelable or dissolvable to facilitate easy cleaning and reuse of the containers.

In addition to human-readable data, the labels 208, 210, and 212 may include machine-readable indicia such as barcodes or QR codes. These codes embed the unique Label ID assigned by the alert station 102, which links the physical container to the digital database. When scanned, the code retrieves the full record of the food item, including preparation history, storage location, and expiration projections. This feature improves over prior systems where food containers could not be individually tracked once stored.

The labels also provide traceability. For example, if a food safety incident occurs, staff can read the label on container 202 to identify its Label ID and obtain associated records from the alert station 102. This rapid trace-back capability allows contaminated or expired food items to be quickly identified and removed, an improvement over existing systems where staff would have to manually search logs.

Another improvement illustrated in FIG. 3 is that each container 202, 204, 206 can be uniquely identified, even if they contain the same type of food. In prior systems, multiple containers of the same dish (e.g., soup or sauce) might be labeled with the same preparation date but no individual identifier, leading to confusion about which container was placed first. In the present system, container 202 may carry Label ID “5-240924,” container 204 may carry Label ID “6-240924,” and container 206 may carry Label ID “7-240924,” ensuring precise FIFO rotation.

In one embodiment, the containers 202, 204, and 206 may further include embedded sensors 254 that communicate with the labels 208, 210, 212 or directly with the alert station 102. These sensors may measure temperature, humidity, or exposure to ambient air when the container is opened. The measured data can be used by the alert station to dynamically adjust the remaining shelf life of the food, providing a more accurate representation of freshness compared to static expiration dates.

In another embodiment, labels 208, 210, and 212 are produced using heat-resistant or freezer-grade materials, allowing them to withstand environments ranging from hot kitchens to cold storage. This is a significant improvement over conventional paper stickers, which often smear, curl, or fall off, leading to lost tracking data.

Thus, FIG. 3 illustrates a key improvement of the present disclosure that the combination of food containers with digitally linked labels that provide both human-readable and machine-readable information, ensuring that each item can be accurately tracked, rotated according to FIFO principles, and monitored for compliance. Unlike existing systems, which rely on manual notations and sporadic checks, the present system 100 ensures continuous, automated oversight of every container from preparation to consumption or disposal.

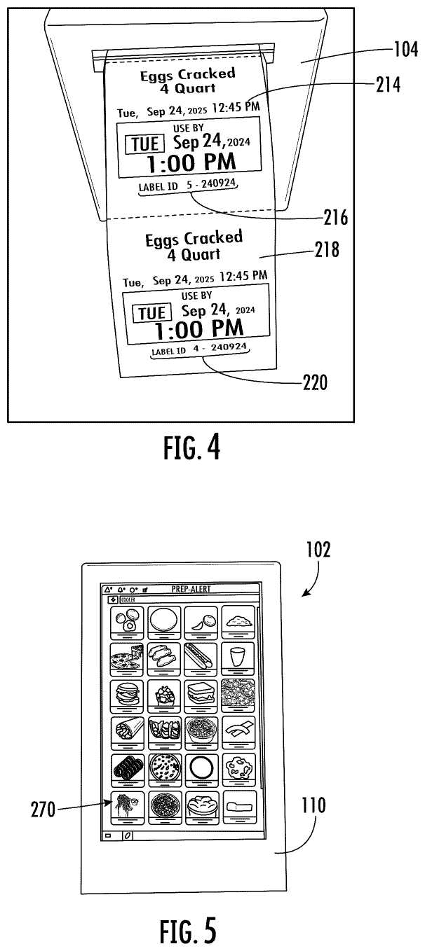

Referring now to FIG. 4, a label generated by the alert station 102 is shown and generally designated 214. The label 214 includes a unique Label ID 216, which in the illustrated embodiment is “5-240924.” Each Label ID 216 comprises a sequence of alphanumeric characters that may encode several pieces of information, such as a sequential identifier, a date code, and an optional location code. For example, “5-240924” may indicate the fifth container created on Sep. 24, 2024. This system of unique identification improves over prior labels, which typically display only a handwritten or printed date and lack any means for distinguishing between multiple containers prepared at the same time.

In addition to the Label ID 216, the label 214 may include descriptive information such as the type of food, preparation date, and expiration date. These elements may be displayed in human-readable text format using high-contrast fonts for legibility in low-light storage environments.

In a particular aspect, the label 214 may also include machine-readable indicia, such as a barcode 246 or a QR code 248. The barcode or QR code encodes the Label ID and may additionally include metadata such as storage location, batch number, or responsible user. When scanned with a handheld scanner or mobile device 227, the code retrieves the associated digital record from the alert station database 108. This ensures fast, error-free retrieval of information.

The labels may also be designed in different formats for different applications. For example, a small-format label may be used for single-serving containers, while a larger-format label may be used for bulk containers. In one embodiment, the alert station 102 automatically adjusts the label size and formatting depending on the selected food category or storage condition.

The improvements over existing systems lies in the transformation of a simple static label into a dynamic information carrier. Prior systems generally provide only a handwritten or printed date, which can fade, smear, or be misinterpreted. By contrast, the label 214 integrates unique identifiers linked to a digital monitoring system. This ensures that every container is uniquely identified, continuously tracked, and easily verified, significantly reducing food waste and improving regulatory compliance.

Referring now to FIG. 5-8, a graphical user interface (GUI) for the alert station 102 is shown and generally designated 270. The GUI is displayed on the display screen 110 of the alert station 102 and provides the primary user interface for interacting with the food rotation and labeling system 100. The GUI 270 is configured to present food inventory data in a structured, intuitive layout that enables rapid navigation and immediate visibility of critical information.

The GUI 270 includes a main display region that shows a list of food items currently tracked by the system 100. Each food item entry is displayed alongside its unique Label ID, preparation date, expiration date, and current status (e.g., “Fresh,” “Expiring Soon,” “Expired,” “Consumed,” or “Discarded”). This consolidated view improves over prior systems, which require staff to physically check containers or rely on paper logs, by providing an at-a-glance, centralized display of all tracked items.

In the illustrated embodiment, the GUI 270 further includes a navigation bar 224 that allows the user to filter or sort food items by category (e.g., dairy, meat, produce, prepared meals) or by storage location (e.g., refrigerator, freezer, dry pantry). This functionality ensures that a kitchen manager can focus on specific groups of items, such as “Frozen meats expiring in the next 48 hours,” without having to scroll through irrelevant entries.

The GUI 270 also includes selectable icons for initiating key functions, such as printing a new label, searching for a specific Label ID, or generating a report. The control panel may be displayed along the top, sides or bottom of the screen 110 and may include touch-sensitive buttons, physical keys, or a combination thereof.

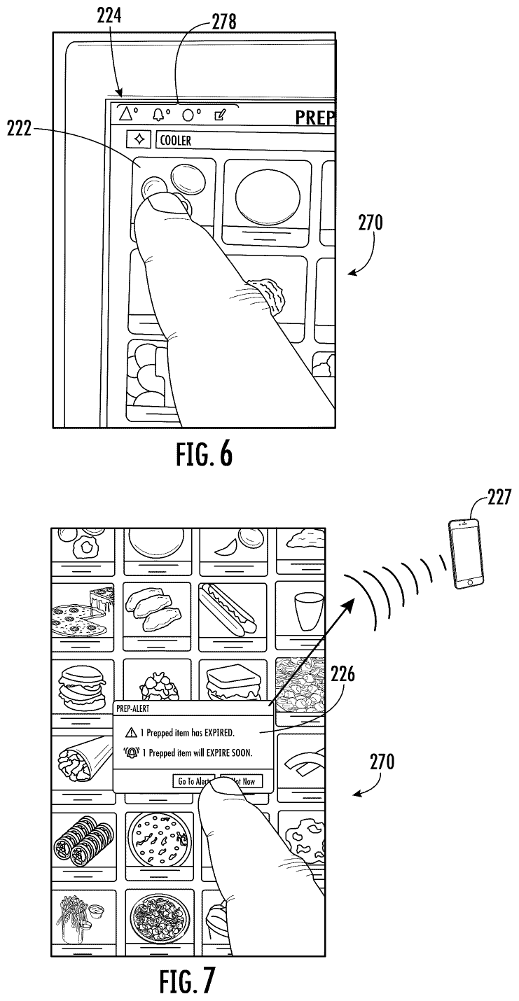

At the top of the GUI 270 is an alert indicator 278. The alert indicator bar includes icons 224 (FIG. 6) that signal the number and severity of pending alerts. For example, a yellow icon may indicate “3 items expiring soon,” while a red icon may indicate “1 item expired.” By consolidating this information in a single visible region, the system improves over prior art methods that rely on staff to manually inspect items, reducing the risk that critical expiration events are overlooked.

The GUI 270 is further configured to display context-sensitive windows or pop-ups 226. For instance, when a food item 222 is selected using the GUI 270, a pop-up window may appear showing detailed information about that item, including handling notes, allergen warnings, or a record of all previous actions (e.g., label printed, container moved, status updated). This ensures full traceability and compliance reporting, a capability absent in prior manual labeling systems.

In one embodiment, the GUI 270 includes a dashboard view that aggregates inventory statistics. The dashboard as shown in FIG. 8 may be used to generate graphs or charts summarizing categories of food nearing expiration, percentages of items consumed versus discarded, or historical waste trends. This feature enables managers to identify patterns of inefficiency and take corrective action, such as ordering smaller batch sizes or adjusting storage practices.

In another embodiment, the GUI 270 includes a multi-user login feature, where users must enter credentials before accessing the interface. Each user's actions are logged and associated with their account. This prevents unauthorized changes to expiration data and ensures accountability in regulated environments such as hospitals or institutional food services.

The GUI 270 can also be customized to match the needs of different environments. For example, the interface may be simplified to show only a small number of tracked items and to emphasize reminders via email or text message. Alternatively, the GUI 270 may include advanced reporting, integration with inventory management software, and remote access via cloud services.

In the illustrated embodiment, the icons 224 are arranged in a row across the top portion of the GUI 270 and include categories such as “Fresh,” “Expiring Soon,” and “Expired.” Each icon may be accompanied by a numeric badge that displays the number of items in that category. For example, a yellow triangle icon may display the number “3,” indicating that three items are within two days of expiration, while a red circle icon may display “1,” indicating that one item has already expired.

When a user selects or taps one of the icons 224, the GUI 270 may be configured to filter the main display region to display only the items associated with that alert category. For example, selecting the “Expiring Soon” icon will display a list of only those food items nearing expiration, including their Label IDs, preparation dates, expiration dates, and storage locations. This interaction saves staff time compared to scrolling through a long inventory list and ensures that high-priority items are addressed immediately.

In one embodiment, the icons 224 may also flash or change intensity to indicate urgency. For example, an icon may transition from yellow to red as the expiration date approaches or may pulse when a newly expired item is detected. This real-time responsiveness provides a level of situational awareness not achievable with static paper labels.

The GUI 290 further includes a menu 230 that allows the user to immediately acknowledge an alert, mark the item as “Discarded” or “Consumed,” or reprint the label if it has become damaged or detached. These contextual options streamline user interaction and ensure that necessary updates are recorded in the alert station database 108 with minimal effort.

In some embodiments, the icons 224 are linked to escalation rules. For example, if an item remains in the “Expired” category for more than 24 hours without being marked as discarded, the system may automatically generate a higher-level alert that is transmitted to a manager's mobile device 227. This escalation ensures accountability and regulatory compliance, particularly in institutional settings where expired items must be promptly removed from circulation.

In another embodiment, the GUI 270 can be customized to match user preferences or regulatory standards. For instance, a user may configure the “Expiring Soon” threshold to three days instead of two, or add additional categories such as “Frozen-Long Term” or “Ready-to-Serve.” The ability to configure alert thresholds and categories makes the system 100 adaptable to different environments, such as commercial kitchens, hospitals, or household use.

Referring now to FIG. 8, an alert 226 generated by the alert station 102 is shown displayed on the display screen 110. The alert 226 provides a notification to the user regarding the status of one or more food items tracked by the system 100. In the illustrated embodiment, the alert is prominently displayed as a pop-up window that overlays the GUI interface 270, ensuring the message cannot be overlooked during operation. The alert 226 may include the Label ID of the affected item, the associated expiration date, and a clear message such as “Item Expiring Soon” or “Item Expired.”

The visual format of the alert 226 is designed for maximum clarity. For example, an “expiring soon” alert may be displayed with a yellow background and a countdown timer showing the number of hours or days remaining until expiration, while an “expired” alert may be displayed with a red background and a flashing border to emphasize urgency. This design improves over conventional static labels that require the user to calculate dates manually and can easily be overlooked.

The transmission of the alert 226 to a mobile device 227, such as a smartphone, tablet, or wearable device is generated from the alert station 102. As explained above, the alert station 102 includes a communication module 120 configured to send alerts through one or more communication channels, including SMS text messaging, email, push notifications, or integration with third-party messaging platforms. In one embodiment, the mobile alert mirrors the display alert by including the Label ID, expiration date, and food category, along with quick-action buttons to acknowledge or dismiss the alert.

In some embodiments, the alerts transmitted to mobile devices 227 include interactive elements. For example, the recipient may tap a “Mark Consumed” or “Mark Discarded” button within the alert, and the mobile device 227 transmits the update back to the alert station 102. This allows remote users, such as supervisors or managers, to maintain accurate records without being physically present at the storage site.

The alert system 100 may also include escalation protocols. For instance, if a first-level alert (e.g., “Expiring Soon”) is not acknowledged within a predefined timeframe, the system may be configured to automatically escalate the notification to a higher-level user such as a kitchen manager, food safety officer, or administrator. Similarly, if an “Expired” item remains unaddressed in the database for more than 24 hours, a follow-up alert may be generated and transmitted to a broader group of users. This escalation feature improves accountability and ensures regulatory compliance, particularly in institutional and commercial environments.

In one embodiment, the alerts 226 are prioritized by severity. For example, “Expired” alerts may override all other notifications and be displayed at the top of the mobile screen until they are acknowledged, while “Expiring Soon” alerts may be grouped and displayed as secondary notifications. The prioritization logic ensures that critical food safety risks are addressed first.

The mobile alerts may also include contextual information beyond what is displayed on the label itself. For instance, the alert may include storage location data (e.g., “Freezer 2, Middle Shelf”), preparation details (e.g., “Prepared by User ID 12 at 10:34 AM”), and handling notes (e.g., “Contains peanuts”). This additional data allows staff to locate and manage the item quickly, reducing time spent searching through multiple containers.

Another improvement includes the feature of the system 100 to maintain a log of all alerts sent and all actions taken in response. Each alert is time-stamped, and the database records whether it was acknowledged, dismissed, or escalated. This creates a digital audit trail that is invaluable for regulatory inspections, internal audits, and liability protection. Prior systems that relied solely on paper labels had no such accountability features, leaving organizations vulnerable to compliance failures.

In some embodiments, the system 100 may also integrate with external calendaring or scheduling software. For example, when an alert is generated, the system may be configured to automatically create a task or reminder in a calendar application of the user, ensuring that the food rotation task is incorporated into daily workflows.

In one embodiment, the GUI 270 includes a timeline or history panel that shows all actions taken with respect to the food item. Entries may include “Label generated,” “Placed in Refrigerator,” “Status updated to Expiring Soon,” “Alert sent to User ID 12,” and “Item marked as Discarded.” Each entry is time-stamped and linked to a user account. This creates a digital audit trail that improves accountability and ensures compliance with food safety regulations. Prior systems relying on paper logs or manual checks offered no such verifiable traceability.

The GUI 270 may also provide quick-action buttons that allow a user to perform tasks such as reprinting the label, marking the item as consumed, or discarding the item. When an action is taken, the alert station database 108 is immediately updated, and the change is reflected across all connected devices. This prevents duplication of effort and ensures that inventory records remain consistent across multiple users.

In some embodiments, he GUI 270 may further include predictive indicators based on system analytics. For example, if historical data suggests that certain items are often discarded before expiration, the system may flag those items with a recommendation such as “Consider smaller batch sizes.” This predictive functionality enables data-driven decision-making to reduce waste and improve efficiency, which is not available in existing static labeling systems.

In another embodiment, the GUI 300 may integrate with external systems such as point-of-sale (POS) terminals, enterprise resource planning (ERP) software, or hospital dietary management systems. In this configuration, when a food item is consumed or sold, the external system automatically updates the Label ID record to “Consumed.” This seamless integration eliminates redundant data entry and ensures real-time accuracy of inventory records.

Thus, the present system 100 improves over existing systems by providing a comprehensive, item-level digital record linked to a unique Label ID. The GUI 270 consolidates preparation data, expiration status, user actions, and historical records into a single, accessible interface. This level of detail and traceability is not achievable with handwritten labels or stand-alone label printers, and it provides significant benefits in terms of compliance, waste reduction, and accountability.

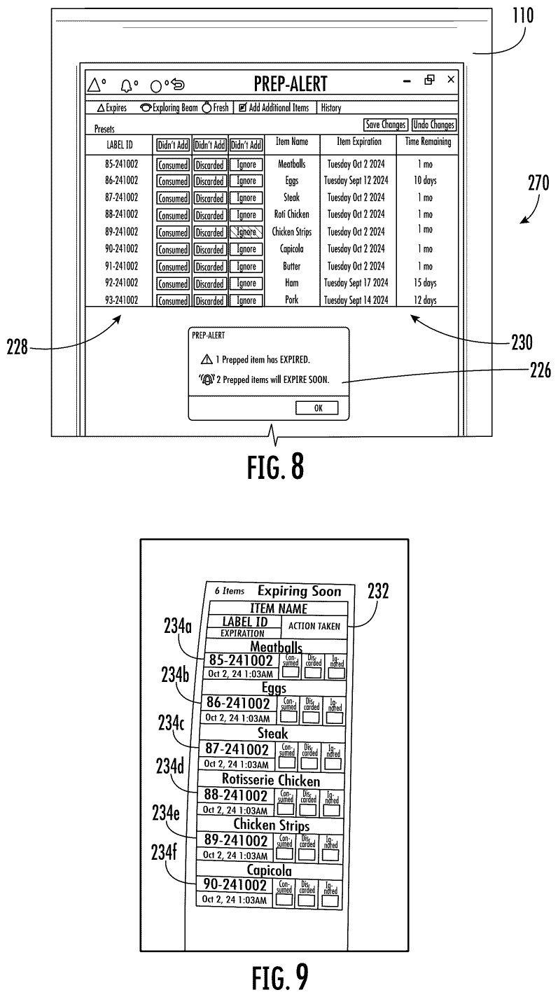

Referring now to FIG. 9, a printed list 232 generated by the alert station 102 is shown. The list 232 includes a series of Label IDs 234a-f corresponding to food containers currently tracked by the system 100. Each Label ID on the list 232 is linked to a unique food item and its associated digital record, thereby allowing the physical list to serve as a portable extension of the alert station database 108.

In the illustrated embodiment, each entry on the printed list 232 includes the Label ID, preparation date, expiration date, food category, and current status (e.g., “Fresh,” “Expiring Soon,” “Expired”). The list 232 may also include storage location identifiers such as “Refrigerator 1—Top Shelf” or “Freezer 2—Drawer 3.” This structured format improves upon traditional handwritten notes, which are often incomplete, inconsistent, or illegible.

The printed list 232 is configured for use during physical inspections of storage areas. A user can carry the list into the kitchen, refrigerator, or freezer and compare the printed Label IDs 234a-f with the physical labels affixed to containers (FIG. 2). Because the IDs are unique, there is no ambiguity in matching containers to their records, even if multiple containers contain the same type of food prepared on the same date.

The list 232 may also be formatted with checkboxes 312 alongside each Label ID. This allows staff to physically mark items as “Verified,” “Consumed,” or “Discarded” during an inspection round. When the list 232 is brought back to the alert station 102, the checked entries can be scanned or entered into the database to update the system records. In one embodiment, the system supports optical character recognition (OCR) or scanning of marked lists, enabling automatic updates without requiring manual data entry.

The list 232 may be generated on demand or according to a schedule. For example, the system 100 may automatically generate a daily inspection list each morning or a weekly audit list every Friday. Lists can be customized to include only certain categories (e.g., “All items expiring within three days” or “Frozen items only”), enabling targeted inspections.

In some embodiments, the list 232 includes summary statistics, such as the total number of items in inventory, the number of items nearing expiration, and the number of items already discarded in the current reporting period. These statistics provide managers with a quick overview of inventory health and help identify patterns of waste.

The improvements of the current system 100 over existing systems are significant. In conventional practice, staff often carry handwritten notebooks or clipboards with manually recorded information about food items. These records are error-prone, difficult to update, and disconnected from digital systems. By contrast, the printed list 232 generated by the alert station 102 is synchronized with the database 108, includes unique identifiers for unambiguous matching, and supports both manual and digital feedback loops. This hybrid approach combines the convenience of paper-based inspections with the accuracy and automation of digital systems.

Thus, the present system 100 bridges digital monitoring with physical verification tools. By generating current, structured, and scannable lists, the system 100 ensures that inspections are efficient, accurate, and fully traceable. This functionality further enhances compliance, reduces food waste, and ensures accountability across food service operations.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

1. A food rotation and labeling system comprising:
a label maker configured to print a label including a unique identifier for a food container;
an alert station operatively coupled to the label maker, the alert station comprising:
a processor, a memory, and a display screen;
the processor configured to store the unique identifier and associated food data including at least a preparation date and an expiration date in the memory;
the processor configured to generate a graphical user interface (GUI) displayed on the display screen and configured to present the food data and status of each food container; and
the processor configured to display an alert on the display screen and transmit the alert to a mobile device when a food container is approaching expiration or has expired.

2. The system of claim 1, wherein the label includes human-readable information comprising at least a preparation date and the expiration date.

3. The system of claim 1, wherein the GUI includes icons indicating food items that are fresh, expiring soon, or expired, each icon displaying a count of the corresponding food items.

4. The system of claim 1, wherein the processor is is further configured to escalate the alert to a supervisor if the alert is not acknowledged within a predefined time period.

5. The system of claim 1, wherein the alert station further comprises a network communication module configured to synchronize the food data with a cloud-based server.

6. The system of claim 1, wherein the label maker is configured to print at least one of water-resistant, freezer-safe, and dissolvable labels.

7. The system of claim 1, wherein the GUI is configured to receive a manual user input corresponding to the unique identifier of the label to update a status of the food container in the food data.

8. The system of claim 1, wherein the processor is further configured to generate a printed list of food containers and their respective identifiers.

9. The system of claim 8, wherein the printed list further comprises fields for manual verification of each food container by comparing the unique identifier on the label to the identifier on the printed list.

10. The system of claim 1, wherein the GUI further comprises a notes field configured to associate at least one of handling instructions and allergen information with the food container.

11. A method of managing food inventory using a food rotation and labeling system, the method comprising:
generating, by an alert station, a label having a unique identifier and printing the label using a label maker;
affixing the label to a food container;
storing, in a database of the alert station, food data associated with the unique identifier, including a preparation date and an expiration date;
operating the alert station to monitor the food data and automatically update a status of the food container; and
operating the alert station to generate an alert when the food container is approaching expiration or has expired, the alert being displayed on the alert station and transmitted to a mobile device.

12. The method of claim 11, further comprising manually reading the unique identifier on the label and entering the identifier into the alert station to update the status of the food container in the database.

13. The method of claim 11, wherein the alert includes interactive options to mark the food container as consumed or discarded.

14. The method of claim 11, further comprising generating a printed list of food containers and their unique identifiers for physical inspection.

15. The method of claim 11, wherein the alert escalates to a supervisor when not acknowledged within a predetermined time.

16. The method of claim 11, further comprising recording a history of actions associated with each food container, including label generation, storage, and disposal.

17. A food container comprising:
a body configured to store food; and
a label affixed to the body, the label including a unique identifier corresponding to a record stored in a database of an alert station, the record including at least a preparation date and an expiration date of the food.

18. The food container of claim 17, wherein the label further comprises at least one of a barcode and a QR code encoding the unique identifier.

19. The food container of claim 17, wherein the label is at least one of water-resistant, freezer-safe, and dissolvable.

20. The food container of claim 17, wherein the label further comprises a color-coded indicator corresponding to a freshness status of the food.
